(19) United States
(12) Patent Application Publication
(10) Pub. No.: US 2012/0112058 A1
(43) Pub. Date: May 10, 2012

(54) SURFACE COATING FOR LASER DESORPTION IONIZATION MASS SPECTROMETRY OF MOLECULES

(75) Inventors: Gitta Vaczine-Schlosser, Esztergom (HU); Carolina Ribbing, Aachen (DE); Peter Klaus Bachmann, Wuerselen (DE); Vitaly P. Zubov, Moscow (RU); Dmitry V. Kapustin, Moscow (RU)

(73) Assignee: KONINKLIJKE PHILIPS ELECTRONICS N.V., EINDHOVEN (NL)

(21) Appl. No.: 13/383,062

(22) PCT Filed: Jul. 5, 2010
(86) PCT No.: PCT/IB2010/053069

§ 371 Date: Jan. 9, 2012

(30) Foreign Application Priority Data
Jul. 9, 2009 (EP) 0916509.1

(51) Int. Cl. H01J 49/26; H01J 49/40

(52) U.S. Cl. 250/282

(57) ABSTRACT

The present invention refers to a process for laser desorption ionization mass spectrometry using a polymer of aniline or an aniline derivative, or phenyl acrylate or a phenyl acrylate derivative. The polymer is a UV absorbing polymer onto which polymer a sample probe can be deposited. With the use of a UV laser beam, the sample molecules can be desorbed and ionized. The addition of a UV absorbing matrix material may not be necessary any more.

### FIELD OF THE INVENTION

The present invention relates to a process for laser desorption ionization mass spectrometry using a polymer as UV absorption medium onto which the sample probe of interest is deposited.

### BACKGROUND OF THE INVENTION

Mass spectrometry (MS) is a widely used analytical method for determining the molecular mass of various compounds. It involves transfer of the sample molecules to the gas phase and ionization of the molecules. Molecular ions are separated using electric or magnetic fields in high vacuum based on their mass-to-charge (m/z) ratios. During the last decades, MS has proven to be an outstanding technique for accurate and sensitive analysis of biopolymers, like proteins and peptides. With the introduction of soft ionization techniques such as electro spray ionization (ESI) and matrix-assisted laser desorption ionization (MALDI), it became possible to transfer into the gas phase and ionize these non-volatile, large, and thermally labile molecules without dissociating them.

In matrix-assisted laser desorption ionization, the sample molecules are co-crystallized with a so-called matrix, a UV absorbing aromatic compound which is added to the sample in large excess. A pulsed UV laser supplies the energy for ionization and desorption of the material, e.g. a protein that is to be analyzed. The matrix absorbs the photon energy and transfers it to the sample. MALDI ionization is, in most cases, combined with time-of-flight (TOF) analyzers. Separation of ions is achieved by accelerating them into a field-free flight tube and measuring their flight time. The flight time of the ions is proportional to their m/z value. Using MALDI-TOF-MS, molecules with masses over 10⁵ Da can be ionized and analyzed without appreciable fragmentation.

Prior to performing MALDI-MS, complex samples like cell lysates, and clinical samples like blood serum have to be prefractionated in order to eliminate salts and detergents and to reduce sample complexity. Common prefractionation methods include liquid chromatography, electrophoresis, and isoelectric focusing. In the early 1990s, MALDI was further refined by introduction of a combination with chromatographic sample prefractionation in surface-enhanced affinity capture (SEAC), later surface enhanced laser desorption ionization (SELDI), and by covalent binding of matrix to the sample holding plate in an approach called surface-enhanced neat desorption (SEND).

In SELDI, the sample is prefractionated on a chromatographic surface which binds a subgroup of sample molecules. Each sample is separated on one spot of a target surface (chip). The chromatographic targets are accommodated in a special holder, a so-called bioprocessor in a microtiter plate format which allows fast work-up of a large number of samples at the same time. Unbound molecules are removed by washing with buffer. Similar to MALDI, a UV-absorbing compound (“matrix”) is added to the spot as a last step before MS measurement. Ionization of the sample is performed directly from the chromatographic surface. Like in MALDI-MS, matrix addition is one of the most sensitive steps in the sample preparation procedure. The matrix solution is very volatile and usually added in very low volumes (0.5-2 μL). The matrix solution dissolves the biological sample molecules and the matrix material co-crystallizes with these biomolecules. Both pipetting and co-crystallization are dependent on temperature and humidity of the surrounding air. Therefore, a large part of the variation in MALDI and SELDI process relates to the matrix addition step. Moreover, the analysis of low molecular weight biopolymers using MALDI or SELDI is hindered by the fact, that the matrix itself is also ionized and desorbed. This gives strong background signals at low masses (approx. below 1000-1500 Da) which makes it very difficult, if not impossible, to detect sample species in this low mass range.

From blood serum, diagnostic mass spectrometric proteomic patterns showing e.g. early stages of cancer or host response to infections can be obtained. The approach of a spectral pattern as a diagnostic discriminator represents a new diagnostic paradigm. The pattern itself is the discriminator, independent of the identity of the proteins or peptides. However, both, MALDI- and SELDI-MS can hardly be used for routine experiments in this field, mostly because of the limited reproducibility (large coefficient of variation) originating mainly from e.g. chromatographic targets and the sensitive matrix addition step.

### SUMMARY OF THE INVENTION

There may be a need for a process for laser desorption ionization mass spectrometry which is not limited by strong background signals. There may be a further need for a process which makes the addition of a matrix compound superfluous.

A first aspect of the invention provides a process for laser desorption ionization mass spectrometry comprising the steps of

(a) depositing a sample probe comprising a sample molecule on a surface of a sample holder, the surface comprising a polymer comprising a UV absorbing aromatic monomer unit;

(b) irradiating the sample probe and/or the surface with a UV laser beam thereby effecting an ionization and/or desorption of the sample molecule; and

(c) determining the mass of the ionized sample molecule.

One basic idea of the present invention is to eliminate the need of a matrix material, as conventionally used hitherto e.g. in MALDI or SELDI techniques, by a surface of polymeric material. The inventors found that this can be achieved by the inventive process and especially by the use of a polymer having UV absorbing aromatic units.

In an embodiment of the first aspect of the invention, the absorbing aromatic monomer unit may be selected from aniline or an aniline derivative, or phenyl acrylate or a phenyl acrylate derivative.

In another embodiment of the present invention, said aniline derivative may comprise a compound according to Formula I

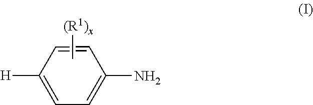

wherein

R¹ is, independently, selected from OH, COOH, halogen, NO₂, NH₂, substituted or unsubstituted, linear or branched alkyl or alkoxy; and

x is 1 to 4.

In still another embodiment, the phenyl acrylate derivative may comprise a compound of Formula II

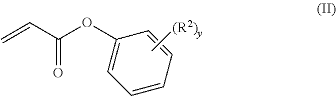

wherein

R² is, independently, selected from OH, COOH, halogen, NO₂, NH₂, substituted or unsubstituted, linear or branched alkyl or alkoxy; and

y is 1 to 5.

In a further embodiment of the first aspect of the invention, said UV absorbing aromatic monomer unit is selected from aniline, 3-amino benzoic acid, and p-nitrophenyl acrylate.

In yet another embodiment of the first aspect of the invention, said polymer is a homopolymer or a co-polymer.

In another embodiment of the first aspect of the invention, said polymer is a homopolymer of aniline, 3-amino benzoic acid, or p-nitrophenyl acrylate, or a co- polymer of aniline and 3-amino benzoic acid.

In another embodiment of the first aspect of the invention, said surface comprises a coating of a polymer on a substrate of a substrate holder, or a bulk polymer fixed on a substrate holder.

In an embodiment of the first aspect of the present invention, the substrate may be selected from glass, silicon, plastic, resins, metal, metal alloys, foil and paper.

In a further embodiment of the first aspect of the present invention, the sample probe is deposited on said surface as a solution comprising or consisting of the sample molecule and a solvent.

In yet another embodiment of the first aspect of the present invention, the solvent is evaporated prior to step (b) when the sample molecule is deposited on said surface in combination with a solvent.

In still another embodiment of the first aspect of the present invention, the sample probe in step (b) contains no UV absorbing material other than said polymer comprising a UV absorbing aromatic monomer unit, especially no additional UV absorption matrix material.

In another embodiment of the first aspect of the present invention, said detecting the mass is achieved by time-of-flight mass spectrometry.

A second aspect of the invention refers to the use of a polymer containing a UV absorbing aromatic monomer unit in a laser desorption ionization mass spectrometry process as UV absorbing material.

All embodiments of the first aspect can be applied mutatis mutandis to the second aspect of the invention. In other words, all embodiments referring to a process can be transferred to the use of a polymer, like especially all embodiments referring to the polymer itself.

### BRIEF DESCRIPTION OF THE DRAWINGS

FIG. 1 shows a mass spectrum of Angiotensin II peptide (M=1045.5 Da) on a PANI-PABA surface;

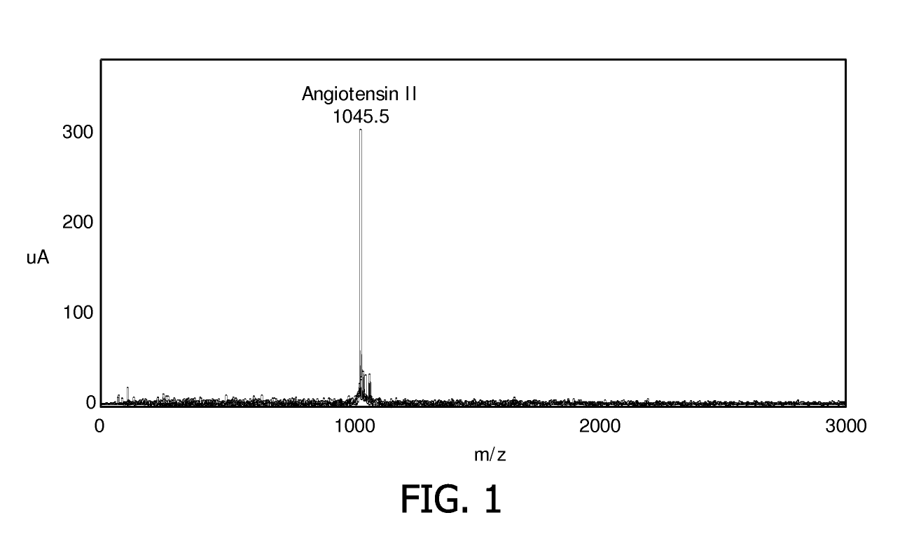

FIG. 2 shows a mass spectrum of Bradykinin fragment 1-7 peptide (M=756.4 Da) on a PANI-PABA surface;

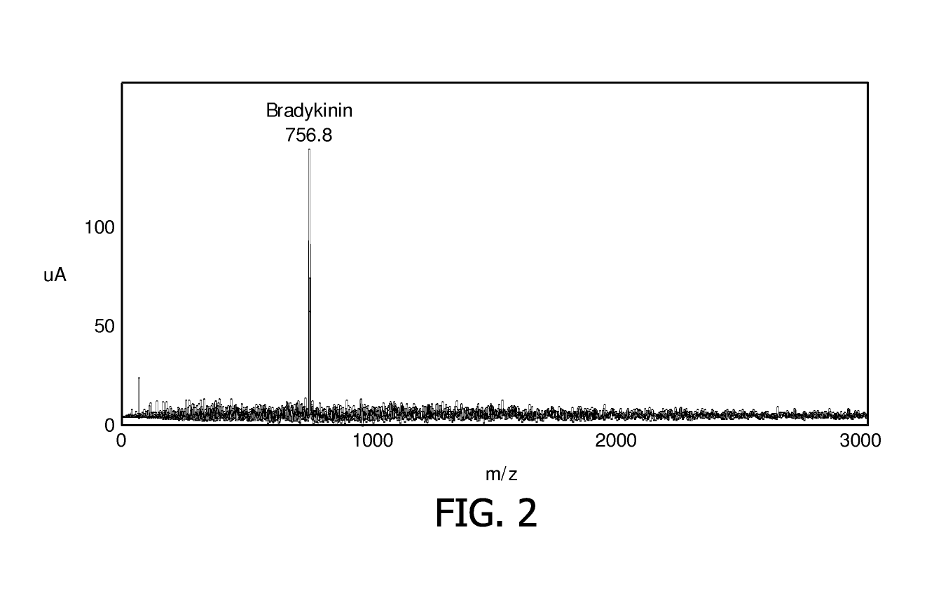

FIG. 3 shows a mass spectrum of bovine insulin protein (M=5735 Da) on a PANI-PABA surface;

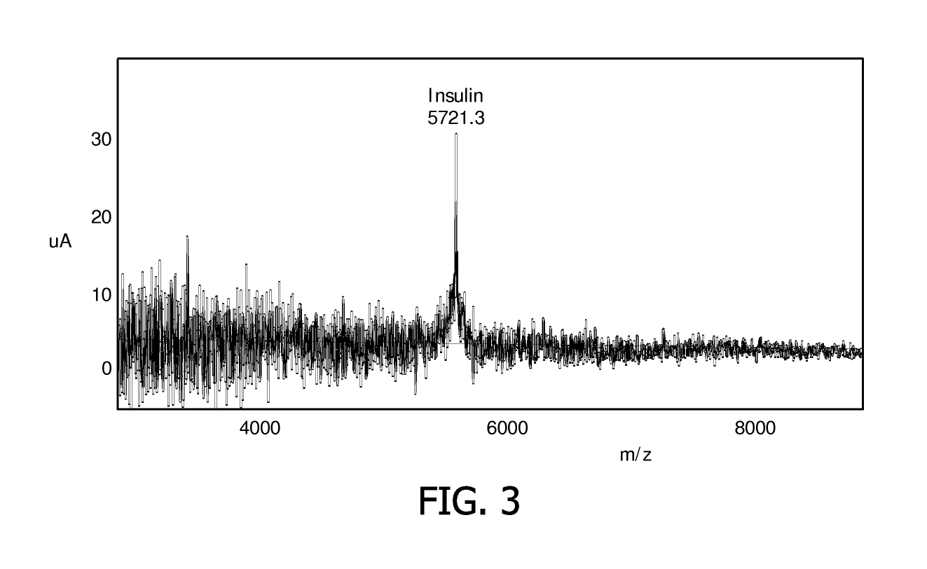

FIG. 4 shows a mass spectrum of Bradykinin fragment 1-7 peptide (M=756.4 Da) on a PANI-PABA surface without matrix addition;

FIG. 5 shows a mass spectrum of Bradykinin fragment 1-7 peptide (M=756.4 Da) on a PANI-PABA surface using a CHCA matrix;

FIG. 6 shows a mass spectrum of Bradykinin fragment 1-7 peptide (M=756.4 Da) on a PANI-PABA surface using a SPA matrix; and

FIG. 7 shows a mass spectrum of Bradykinin fragment 1-7 peptide (M=756.4 Da) on an uncoated Si-strip without matrix addition (reference example).

### DETAILED DESCRIPTION OF EMBODIMENTS

In the following, exemplary embodiments are described. It is to be understood that these embodiments are exemplary embodiments, and the features of different embodiments can be combined in any possible manner.

A first aspect of the invention provides a process for laser desorption ionization mass spectrometry comprising the steps of

(a) depositing a sample probe comprising a sample molecule on a surface of a sample holder, the surface comprising a polymer comprising a UV absorbing aromatic monomer unit;

(b) irradiating the sample probe and/or the surface with a UV laser beam thereby effecting an ionization and/or desorption of the sample molecule; and

(c) determining the mass of the ionized sample molecule.

As already mentioned above, a basic idea of the present invention is to eliminate the need of the matrix material used in MALDI or SELDI techniques by the use of a surface of polymeric material. The polymeric material is obtained by polymerizing monomer units comprising at least one UV absorbing aromatic monomer unit. The use of UV absorbing aromatic monomer units allows for the desorption and ionization of a sample molecule deposited on said surface with a UV laser.

In conventional MALDI or SELDI processes, a matrix compound or matrix material is co-crystallized with the sample molecules in large excess. When a UV laser beam, like a pulsed UV laser beam, is directed to the sample probe comprising the sample molecule and the matrix material, the matrix molecules absorb UV light from the laser beam and thus effect a desorption and ionization of the sample molecules.

With the use of a polymeric material comprising a UV absorbing monomer unit the need for an additional matrix material can be overcome. The sample molecules are deposited directly on the polymeric material, also termed as polymer material. When a laser beam is directed towards the polymeric material, UV light is absorbed by the polymeric material and the energy is transferred to the sample molecules. Thus, the sample molecules are desorbed and ionized for further investigation by mass spectrometry. The addition of a matrix material as UV absorbing material is not necessary, and may thus be omitted.

The fact that no matrix material has to be added, e.g. in order to achieve a co-crystallization, may simplify the process of sample preparation and may additionally reduce the background signal in the subsequent mass spectrometry. As will be illustrated in exemplary embodiments of the present invention, polymeric material comprising a UV absorbing monomer unit may be used to achieve these aims. The process of the present invention may be used to reduce the background signals known from the use of matrix compounds in MALDI- or SELDI-MS. This may open the window for mass spectrometry of larger molecules, like biomolecules, in mass areas which were so far not conceivable, like a mass of the molecule below 2000 kDa, or even below 1500 kDa, or even below 1000 kDa. The sample molecules of the present invention may be biomolecules having a mass below 2000 kDa, or below 1500 kDa, or below 1000 kDa, or below 750 kDa.

The process of the first aspect of the present invention may be applied to any kind of sample to be studied by mass spectrometry. As such, any kind of chemical or biological compound can be deposited on the polymeric surface of a sample holder. In an exemplary embodiment of the first aspect of the invention, the sample molecule may be selected from biomolecules, like peptides, proteins, glycoproteins, and nucleic acids, or bio-organic or synthetic organic molecules.

In an exemplary embodiment of the first aspect of the invention, step (a) of the process may be subdivided into two steps, namely

(a1) applying a polymer comprising a UV absorbing aromatic unit onto the surface of a sample holder; and

(a2) depositing a sample probe comprising a sample molecule on said surface.

In an exemplary embodiment of the first aspect of the invention, the absorbing aromatic monomer unit may be selected from aniline or an aniline derivative, or phenyl acrylate or a phenyl acrylate derivative.

In the context of the present application, whenever reference is made to “aniline” or “phenyl acrylate”, also the derivatives of aniline and phenyl acrylate, respectively, are encompassed, if not specifically stated to the contrary. As such, aniline is equivalent to aniline and aniline derivatives, and phenyl acrylate is equivalent to phenyl acrylate and phenyl acrylate derivatives.

In an exemplary embodiment, the polymers of aniline or an aniline derivative can be used as a chromatographic surface. Such polyaniline or polyaniline derivative surfaces can be used to separate sample molecules of interest from other molecules in a sample by chromatography on the surface. The separation of the molecules and the sample preparation can thus be simplified. Furthermore, the polymers of the present invention can be washed or rinsed without loss of UV absorbing activity. Other than SEND surfaces, wherein UV absorbing matrix molecules are adsorbed to a surface, the UV absorbing units of the present invention are part of a polymer and thus stay within the polymer even when the surface is washed. Such washing steps are usual means when polymers are used as chromatographic surfaces, as in SELDI. The polymers of the present invention can be used as chromatographic surfaces, comparable to SELDI surfaces, however, without the need of applying a matrix material, and without the disadvantage of loosing adsorbed matrix molecules as in conventional SEND surfaces.

In another exemplary embodiment, the polymers of phenyl acrylate or a phenyl acrylate derivative can be used to bind bioligands, like proteins, enzymes, and peptides. The polymer can thus be used as an affinity surface for the immobilization of such bioligands.

As used in this specification and in the appended claims, the singular forms of “a” and “an” also include the respective plurals unless the context clearly dictates otherwise.

Both aniline and phenyl acrylate are UV absorbing molecules. Also, both molecules may serve as monomer units, or monomers, for a polymerization. The polymerization of these compounds lead to polymers which may absorb UV light.

The mechanistical details of ion formation in conventional MALDI or SELDI experiments is still a matter of debate. Without being bound by this theory, the inventors assume that in conventional MALDI or SELDI, the matrix absorbs light due to its electronic structure (pi-systems are frequently involved in conventional matrices), transfers the energy radiationlessly to the biomolecule and desorbs it from the co-crystallized mix of matrix and biomolecule. The co-crystallization of matrix and biomolecule thus is a sensitive time-consuming and potentially irreproducible step. External factors may influence the outcome of the co-crystallization, like the moisture level in room. Accordingly, a co-crystallization should be avoided. The polymers of the present invention can be used without the need of a co-crystallization of a matrix and a biomolecule.

In another exemplary embodiment of the present invention, said aniline derivative may comprise a compound according to Formula I

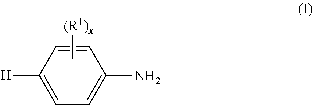

wherein

R¹ is, independently, selected from OH, COOH, halogen, NO₂, NH₂, substituted or unsubstituted, linear or branched alkyl or alkoxy; and

x is 1 to 4.

The phenyl ring of aniline may be substituted to form an aniline derivative. The substitution may be a single substitution of the phenyl ring (x=1), or a twofold, threefold or fourfold substitution. These substitutions may replace the hydrogen atoms in ortho or meta position in respect to the amine substitution of the phenyl ring. The para position in respect to the amine substitution is always unsubstituted.

The substitution pattern of the phenyl ring of aniline may comprise any possible substitution pattern, such as a single substitution in ortho or meta position, or a twofold substitution in ortho position, a twofold substitution in meta position, or any other substitution pattern.

When aniline or aniline derivatives are used as monomers during polymerization, the units may be bound to each other in the para position in respect to the amino group of the aromatic ring. The polymerization of anline and its derivatives may further be influenced by the pH of the polymerization medium. By varying the pH of the polymerization medium, the surface properties, like the surface sorption properties, can be tailored.

The acidity of the reaction mixture for polymerization may have a strong influence on the oxidation of aniline. For instance, a polymer useful in the present invention may be produced in strongly acidic media, like pH<2.5. The redox process between an oxidant and a monomer may be assisted by the conducting polymeric aggregates growing in the reaction mixture. These conditions are preferred in the formation of coatings for the present invention. At a pH higher than 2.5, a polymerization may become more difficult, and shorter chains may result. Also, the kind of coupling may be influenced, like a mix of ortho and para coupling of aniline or aniline derivatives may result.

The pH may also influence the final polymer of aniline or an aniline derivative. The polymers may be reversibly transformed. This effect is known from PANI, which may be reversibly transformed from blue protonated Pernigraniline (showing usually a low sorption ability to biomolecules, like proteins) through green protonated Emeraldine to stable blue Emeraldine base (showing usually a high sorption ability), and then to violet Pernigraniline base.

As outlined above, the aniline polymers of the present invention can be tailored for any desired application as the aniline derivatives are redily accessible, show a high degree of derivatization and are easily processable. The polymers can be used either as polymer, e.g. as solution, or the monomers can be polymerized onto a surface.

In still another exemplary embodiment, the phenyl acrylate derivative may comprise a compound of Formula II

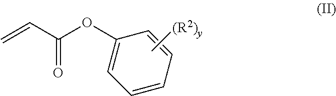

wherein

R² is, independently, selected from OH, COOH, halogen, NO₂, NH₂, substituted or unsubstituted, linear or branched alkyl or alkoxy; and

y is 1 to 5.

The phenyl ring of phenyl acrylate may be substituted to form a phenyl acrylate derivative. The substitution may be a single substitution of the phenyl ring (x=1), or a twofold, threefold, fourfold or fivefold substitution. These substitutions may replace the hydrogen atoms in ortho, meta, or para position in respect to the acrylate substitution of the phenyl ring.

The substitution pattern of the phenyl ring of phenyl acrylate may comprise any possible substitution pattern, such as a single substitution in ortho or meta or para position, or a twofold substitution in ortho position, a twofold substitution in meta position, a substitution in ortho and in para position, or any other substitution pattern.

If the substitution of a phenyl ring of aniline or phenyl acrylate is multifold, the substituents R¹, or R², respectively, may be identical or different, i.e. the substituents R¹, or R², are selected independently.

The substituents R¹ and R² are selected from a hydroxy group (—OH), a carboxy group (—COOH), a halogen, a nitro group (—NO₂), an amino group (—NH₂), or a substituted or unsubstituted, linear or branched alkyl or alkoxy.

“Halogen” or “halo” means —F (fluoro), —Cl (chloro), —Br (bromo), or —I (iodo).

The alkyl substitution may be selected from a (C₁-C₆)alkyl, (C₁-C₄)alkyl, or (C₁-C₂)alkyl. Similarly, the alkoxy substitution may be selected from a (C₁-C₆)alkoxy, (C₁-C₄)alkoxy, or (C₁-C₂)alkoxy. The “alkoxy” substitution is equivalent to an alkyl substitution wherein the alkyl is bound via an oxo group, i.e., a group of the formula —O-alkyl. All definitions referring to “alkyl” may thus be transferred to “alkoxy” wherein alkoxy is an oxo substituted alkyl.

“—(C₁-C₆)alkyl” means a straight chain or branched non-cyclic hydrocarbon having from 1 to 6 carbon atoms. Representative straight chain -(C₁-C₆)alkyls include -methyl, -ethyl, -n-propyl, -n-butyl, -n-pentyl, and -n-hexyl. Representative branched —(C₁-C₆)alkyls include -iso-propyl, -sec-butyl, -iso-butyl, -tert-butyl, -iso-pentyl, -neopentyl, 1-methylbutyl, 2-methylbutyl, 3-methylbutyl, 1,1-dimethylpropyl, 1,2-dimethylpropyl, 1-methylpentyl, 2-methylpentyl, 3-methylpentyl, 4-methylpentyl, 1-ethylbutyl, 2-ethylbutyl, 3-ethylbutyl, 1,1-dimethtylbutyl, 1,2-dimethylbutyl, 1,3-dimethylbutyl, 2,2-dimethylbutyl, 2,3-dimethylbutyl, and 3,3-dimethylbutyl.

“—(C₁-C₄)alkyl” means a straight chain or branched non-cyclic hydrocarbon having from 1 to 4 carbon atoms. Representative straight chain —(C₁-C₄)alkyls include -methyl, -ethyl, -n-propyl, and -n-butyl. Representative branched —(C₁-C₄)alkyls include -iso-propyl, -sec-butyl, -iso-butyl, and -tert-butyl.

“—(C₁-C₂)alkyl” means a straight chain non-cyclic hydrocarbon having 1 or 2 carbon atoms. Representative straight chain -(C₁-C₂)alkyls include -methyl and -ethyl.

With the use of different substituents on either aniline or phenyl acrylate, these compounds can be functionalized. The functionalization of the monomer unit results in a functionalization of the polymer, i.e. functionalized polymers. Such functionalized polymers may be used in chromatographic separation processes, for the immobilization of proteins, enzymes or peptides, or in affinity chromatography. The resulting probes may be analyzed by the inventive process.

In another exemplary embodiment of the first aspect of the invention, said UV absorbing aromatic monomer unit is selected from aniline (ANI), 3-amino benzoic acid (3-ABA), and p-nitrophenyl acrylate (NA).

In yet another exemplary embodiment of the first aspect of the invention, said polymer is a homopolymer or a co-polymer.

The polymer of the present invention may be homopolymer of any of the above mentioned monomer units. In other words, the monomer unit used to make the polymer is a single monomer unit.

If more than one monomer unit is used to make the polymer, a co-polymer is produced. Such co-polymers can have different monomer units, i.e. two or more different monomer units. Using more than one monomer unit, the polymers may be further functionalized. A person skilled in the art can use routine experiments to determine the functionalization necessary for a certain application.

In another exemplary embodiment, said polymer is a homopolymer of aniline, 3-amino benzoic acid, or p-nitrophenyl acrylate, or a co-polymer of aniline and 3-amino benzoic acid.

The ratio of the monomers in a co-polymer may be any ratio that is polymerizable. A person skilled in the art will, again, choose the ratio of the monomers according to the need of funcitonalization, solubility of the resulting polymer for coating, or stability of the polymer.

In an exemplary embodiment, the ratio of a mixture of two monomers is in the range selected from the ranges of 100:1 to 1:100, 30:1 to 1:30, 10:1 to 1:10, 5:1 to 1:5, 4:1 to 1:4, and 3:1 to 1:3. In an exemplary embodiment, one of the two monomers is 3-aminobenzoic acid. The use of 3-aminobenzoic acid may increase the water solubility of the resulting polymer, especially at a higher ratio. The water solubility may increase with a higher content of 3-aminobenzoic acid in the reaction mixture.

In another exemplary embodiment of the first aspect of the invention, said surface comprises a coating of a polymer on a substrate of a substrate holder, or a bulk polymer fixed on a substrate holder. The surface may also consist of a coating of a polymer on a substrate of a substrate holder.

The polymer used in the present invention is the surface onto which a sample probe is deposited. Said surface may be the surface of a bulk polymer, i.e. the substrate holder may be formed from a bulk polymer or may contain a bulk polymer. In another exemplary embodiment, the surface is the surface of a polymer coating on substrate. The coating of the polymer may be applied to any substrate.

In another exemplary embodiment, the substrate may be selected from a wide variety of materials, including, but not limited to, silicon such as silicon wafers, silicon dioxide, silicon nitride, glass and fused silica, quartz, soda-lime glass, borosilicate glass, acrylic glass, sugar glass, isinglass or aluminium oxynitride, paper, ceramics, polyimide, plastics, resins and polymers including polymethylmethacrylate, acrylics, polyethylene, polypropylene, polyethylene terephthalate, polycarbonate, polystyrene and other styrene copolymers, polytetrafluoroethylene, metals and metal alloys, such as aluminum, steel, gold, silver, copper, tungsten, molybdenum, tantalum, brass, etc. High quality glasses such as high melting borosilicate or fused silica may be preferred for their UV transmission properties. The substrate may also be any flexible material, like paper, rubber, or foil.

In still another exemplary embodiment of the present invention, the substrate may be coated by any known method, depending also on the solubility of the polymer. Soluble and insoluble polymers may be obtained. Accordingly, various techniques may be used to obtain polymer coatings, e.g. precipitation, co-polymerization, casting of a polymer solution, or chemisorption of a polymer on a substrate surface.

The substrate may be pre-treated prior to coating a polymer to the substrate. A pre-treatment of the substrate may comprise sterilization of the substrate, or modification of the substrate surface, like oxidation of the substrate, e.g. on a silicon substrate. A silicon substrate may be converted to an oxidized silicon substrate by heating the substrate and subsequent oxidation of the substrate under oxidative atmosphere, e.g. in air or oxygen. Further, the substrate may be coated or treated with other pre-coating materials. Such pre-coatings may allow for the polymer coating to be applied more easily.

In an exemplary embodiment of the present invention, the substrate may be a Si-surface. Such Si-surfaces may be silaminated to increase the retention of hydrophilic coatings, like PNA or 3-ABA containing coatings. A general procedure for silamination may include the incubation of Si-strips in boiled water, followed by the treatment with an aqueous 5% solution of 3-aminopropyl triethoxysilane. The pre-coating may then be washed and/or dried. In a preferred embodiment, the substrate is oxidized silicon or SiO₂. A surface of oxidized silicon may be prepared from a silicon surface by heating the silicon surface at elevated temperatures, e.g. above 500° C., in an oxidizing atmosphere, like oxygen or air. A surface of oxidized silicon may easily be coated with a polymer of the present invention by casting of a polymer solution onto the surface. Especially the polymers of aniline or aniline derivatives can be easily applied to oxidized silicon surfaces and will remain on such surfaces without any special pre-treatment of the surface other than oxidizing.

The thickness of a coating may be selected from below 1000 nm, below 500 nm, below 250 nm, or below 100 nm. The coating may also be as thin as a few monolayers, like 1 to 10 monolayers, or 2 to 5 monolayers of the polymer. The coating of a monolayer of the polymer may be as thin as below 100 nm, or below 75 nm, or even below 50 nm. The thin coatings of the polymer applied by any of the above given methods show little or no tension or strain, and a reduced delamination of the coating.

Coatings may be applied in a single step, or in repeated coating steps. The coating of a substrate may thus comprise repeated steps of coating of the substrate and drying the coating on the substrate.

Aniline-containing surfaces may bind peptides and proteins, but may not bind nucleic acids. This feature may be used for purification of nucleic acid admixtures and e.g. cell lysates. Furthermore, polyanilines may be pH-sensitive materials. This property may be used for determination of conditions providing selective sorption of peptides and proteins depending on their isoelectric point (pI) values. Furthermore, the poly(aniline) or poly(aniline derivative) may be in protonated (doped) form, or in unprotonated form. The protonation of the poly(aniline) or poly(aniline derivative) may change the ability of the polymer surface to bind biomolecules.

In a further exemplary embodiment of the first aspect of the present invention, the sample probe is deposited on said surface as a solution comprising the sample molecule and a solvent. The sample probe may thus comprise the sample molecules, a solvent, and further compounds. The solvent used for depositing a sample probe can be chosen by a person skilled in the art by routine experiments, e.g. depending on the solubility of the sample probe in the solvent.

In an exemplary embodiment of the first aspect of the present invention, the sample probe is deposited on said surface as a solution consisting of the sample molecule and a solvent. The sample probe may thus consist of the sample molecule and the solvent only, and after an optional evaporation or removal of the solvent, the sample probe may consist of the sample molecule only.

In yet another embodiment of the first aspect of the present invention, the solvent is evaporated prior to step (b) when the sample molecule is deposited on said surface in combination with a solvent. The evaporation may be achieved by known methods, like elevated temperature and/or reduced pressure.

In still another embodiment of the first aspect of the present invention, the sample probe in step (b) contains no UV absorbing material other than said polymer comprising a UV absorbing aromatic monomer unit, especially no additional UV absorption matrix material.

The sample molecules on the surface of the polymer comprising a UV absorbing aromatic monomer unit can be desorbed and ionized using a UV laser beam. The UV radiation may be absorbed by the polymer and the absorbed energy is transferred to the sample molecules. During the laser irradiation step, the surface may be heated. However, the polymers of the present invention show a good thermal and oxidative stability even under such condition. The polymers of the present invention may thus serve as a target for a UV laser beam in a sample molecule desorption and ionization process.

In another embodiment of the first aspect of the present invention, said detecting the mass is achieved by time-of-flight mass spectrometry. However, other methods of mass spectrometry may also be applied, like a sector field analyser, a quadrupole mass analyser, a quadrupole ion trap, a linear quadrupole ion trap, by Fourier transform ion cyclotron resonance, or any other mass analyser.

A second aspect of the invention refers to the use of a polymer containing a UV absorbing aromatic monomer unit in a laser desorption ionization mass spectrometry process as UV absorbing material. All exemplary embodiments detailed above for the first aspect of the invention may also be applied mutatis mutandis to the second aspect of the invention.

As outlined above and as will be apparent from the following examples, the use of the polymers of the present invention have advantages over the prior art using an additional matrix material. The polymers can be produced at low cost and are stable for the use with UV lasers. Further, reproducible results may be obtained in mass spectrometry experiments using the polymers of the present invention as a target for UV lasers.

### EXAMPLES

In the following, the present invention is illustrated by means of Examples. However, these Examples should not be understood as limiting the invention in any way.

### Example 1

### Preparation of Poly-ANI-co-3-ABA

Poly-ANI-co-3-ABA was obtained by oxidative co-polymerisation of aniline (ANI) with 3-aminobenzoic acid (3-ABA) in 1 M HCl under stirring at 55° C. (ammonium persulfate as oxidizer, molar ratio co-monomers:acid:oxidizer=1:8:1) for 20 min. Subsequently, the mixture was added to a 5-fold higher volume of ice water. The obtained product was filtrated, washed with 1 M HCl and water to pH 7 and dried in vacuum. The polymer was precipitated from 96% H₂50₄, washed with water to pH 7 and dried under vacuum. The product yield was determined to be about 40-60%. Aniline-containing polymer modifiers with aniline/3-ABA ratios of 3:1, 1:1 and 1:3 were prepared. The composition was determined using elemental analysis.

### Example 2

### Preparation of Silicon Strips

Both oxidized and non-oxidized silicon strips of 70 mm×8 mm×0.5 mm (Si-strips) were used as substrate to be used in its surface modified, polymer coated form. Oxidized Si-strips were prepared by heating Si-strips to 1000° C. and subsequent treatment for 4 h in air or oxygen.

### Example 3

### Modification of Si-strips

Both oxidized and non-oxidized Si-strips were coated with the co-polymers obtained from Example 1. The co-polymers of Example 1 were suspended or dissolved in tetrahydrofurane (THF), respectively. For the co-polymer having an aniline/3-ABA ratio of 1:1, a solution was obtained, and for the co-polymer having an aniline/3-ABA ratio of 3:1, a suspension (25 mg/ml) was obtained. A 5% solution of the co-polymer having an aniline/3-ABA ratio of 3:1 was prepared in THF. All coatings were prepared through casting, if necessary in several layers. The modified chips were dried in hot air.

The modification of Si-strips with a homopolymer of aniline (PANI) was carried out through precipitative, oxidative polymerization of aniline on Si-strips at room temperature after mixing an aqueous solution of ammonium persulfate with monomer solution in aqueous HCl at molar ratio aniline:acid:oxidizer=1:3:1 for 0.5 h. Modified Si-strips were washed with water, methanol and dried in hot air.

Si-strips modified with a homopolymer of 3-aminobenzoic acid (PABA) was prepared through casting of 5% co-polymer solutions in THF (two layers) followed by drying in hot air.

Substrate surfaces were modified by silamination. Different modes of silamination were used to provide the formation of a uniform coating of chemosorbed PNA.

In a general silamination procedure, the unoxidized Si-strips were incubated in boiled water for 16 h, then placed into aqueous 5% solution of 3-aminopropyl triethoxysilane for 30 min, then washed with water till neutral pH of filtrate and dried under hot air current.

### Example 4

### Analysis of Polymers and Coatings

The compositions of the obtained co-polymers of Example 1 were determined using elemental analysis and IR absorption spectroscopy.

The elemental analysis (based on determination of C, N and H content and on the calculation of the oxygen content) showed that the monomer units were inserted into the macromolecules (see Table 1).

TABLE 1
Comparison of theoretical and determined content of
elements in obtained homopolymers and co-polymers
of aniline with 3-ABA using elemental analysis.

| | | | | | Determined by elemental | | | |
|---|---|---|---|---|---|---|---|---|
| Homopolymer | Theoretical | | | | analysis | | | |
| or co-polymer | C | H | N | O | C | H | N | O |
| PANI | 79 | 6 | 15 | 0 | 81 | 5 | 14 | 0 |
| PANI-ABA | 74 | 4 | 14 | 8 | 59 | 4 | 11 | 26 |
| (3:1) | | | | | | | | |
| PANI-ABA | 69 | 5 | 12 | 14 | 60 | 3 | 10 | 28 |
| (1:1) | | | | | | | | |
| PABA | 63 | 3 | 10 | 24 | 58 | 3 | 8 | 31 |

The data of Table 1 indicate that the co-polymerization results in insertion of 3-ABA units into the macromolecule. Thus, the co-polymers are enriched with 3-ABA units. This was also confirmed by a solubility test. Co-polymers were soluble in THF and a co-polymer of aniline with 3-ABA was soluble in aqueous medium at pH≧9.0, while homopolymers of aniline as well as co-polymer PANI-3-ABA at molar ratio 3:1 was insoluble in water and organic solvents.

IR-spectra of the PANI as well as of co-polymers of aniline with 3-ABA (at molar ratios 3:1 and 1:1) and homopolymer of poly-3-ABA were acquired and analysed. Polymers were suspended (PANI and PANI-3-ABA, 3:1) or dissolved (PABA and PANI-3-ABA, 1:1) in THF and deposited on the KBr plates by solvent evaporation. The absorption maximum at v≅1700 cm⁻¹ (carboxylic group) was increased correspondingly with the increase of the 3-ABA content (determined by elemental analysis).

The stability of coatings based on co-polymers of aniline with 3-ABA was tested in different solutions. It was shown that coatings were stable after incubation in water media at pH range 2-9 for more than 1 h.

### Example 5

### Binding of Proteins and Peptides

The ability of aniline-containing coatings to bind a variety of proteins was studied using Spectral Phase Interference.

Use of thin glass slides (90-120 μm) modified with PANI coatings allows investigating the kinetics and effectiveness of pH-dependent binding of proteins and peptides to the polymer surface. It was shown that a reversible sorption of different proteins on the polyaniline-modified glass surface could be achieved depending on the pH.

Cytrochrome C showed a reversible adsorption to the surface at a pH of 7.2 and was desorbed at a pH of 2.

It was furthermore shown that Cytochrome C (M 12 000), Casein (M 20 000), Myoglobine (M 17 800), IgG (M 125 000) and Poly-L-lysine (M 150 000) could be bound to the surface of the coated Si-strip at pH of 7.2. Calf Thymus DNA and Poly-uridine acid Potassium Salt (Sw 3.4-6.0) were not binding to the surface at the same conditions.

Thus Si-strips with aniline-containing polymer films are suitable to retain specific biological entities.

### Example 6

Binding of Proteins with Different pI Values

The capability of Si-strips modified by aniline-containing coatings to retain model proteins with different pI values, namely bovine serum albumin (BSA) with a pI of 4.8, lysozyme with a pI of 10.5, and pepsine with a pI of 2.8, was investigated using 10 μL of a corresponding protein solution. Three types of modified silicon strips were used.

a) Si-strips modified with PANI by precipitation polymerization.

b) Si-strips modified with PABA by physical sorption from a THF solution and subsequent drying at room temperature.

c) Si-strips modified with PABA by chemical sorption.

The Si-strips of a) and b) were prepared according to Example 3.

Chemical sorption of PABA on the Si-strip surface was carried out as follows:

Two preliminary silaminated Si-strips were inserted into 10 ml of solution of PABA in N,N-dimethylformamide (DMFA) (20 mg/ml) containing dicyclohexylcarbodiimide (123 mg) under stirring at 0±1° C. for 30 min. Then 2 ml of a solution of N-succinimide (83 mg) in DMFA was added to the polymer solution and the system was incubated at room temperature for 4 h. The polymer-coated substrates were washed with DMFA, methanol and water, and then dried in air.

The protein retention was characterized by incubation in protein solution, washing the modified substrates with 10 μl of solutions at different pH (a tris(hydroxymethyl)aminomethane (Tris) HCl buffer solution at pH 9, an aqueous HCl at pH 6, and an aqueous HCl at pH 3), and subsequent optical UV absorption measurements at λ=280 nm (Tables 4-6).

TABLE 2
Retention of BSA on different polymers at different pH values

| | Tris HCl | HCl aq | HCl aq |
|---|---|---|---|
| Polymer modifier | pH 9 | pH 6 | pH 3 |
| PANI | 60.9% | 12.5% | 0% |
| Precipitation | | | |
| polymerization | | | |
| PABA | 23.4% | 39.1% | 0% |
| Physically sorbed | | | |
| PABA | 0% | 7.8% | 3.9% |
| Chemically sorbed | | | |

TABLE 3
Retention of lysozyme on different polymers at different pH values

| | Tris HCl | HCl aq | HCl aq |
|---|---|---|---|
| Polymer modifier | pH 9 | pH 6 | pH 3 |
| PANI | 22.4% | 8.7% | 0.5% |
| Precipitation | | | |
| polymerization | | | |
| PABA | 0% | 7.0% | 0% |
| Physically sorbed | | | |

TABLE 4
Retention of pepsine on different polymers at different pH values

| | Tris HCl | HCl aq | HCl aq |
|---|---|---|---|
| Polymer modifier | pH 9 | pH 6 | pH 3 |
| PANI | 0% | 0% | 8.0% |
| Precipitation | | | |
| polymerization | | | |
| PABA | 0% | 17.5% | 0% |
| Physically sorbed | | | |

This Example shows that replacing aniline units in the polymer by 3-ABA units results in a change of the sorptive properties of the coatings. The coating based on chemically sorbed PABA (Table 4) does not retain proteins as good as the physically sorbed PABA, probably due to the presence of residual amino groups on the Si-strip surface.

### Example 7

### Coating of Co-polymers by Precipitation Polymerization

Coatings of co-polymers of aniline with 3-ABA were formed by oxidative precipitation co-polymerization in the presence of Si-strips at low temperature (12-15° C.) after mixing an aqueous solution of ammonium persulfate with co-monomer solution in aqueous 1M HCl (molar ratio monomer:acid:oxidizer=1:10:1) for 1.5 h. The modified Si-strips were washed with 1M HCl, water and dried in hot air.

To visualize protein retention on the modified PANT-ABA Si-strips, model proteins with different pI were labelled with luminescent (emission at 546 and 581) semiconductor (CdSe)ZnS nanocrystals. Protein solution droplets were put onto the modified surfaces (10 μl of solution, 0.5 mg protein/ml) and incubated for 5 min at ambient temperature. Excess was removed and sorption was optically visualized. The results are presented in Table 5. They correlate well with the data presented in Tab. 2 and 3.

TABLE 5
Retention of Cytochrome C and Myoglobine on Si-
strips coated by precipitation polymerization.

| | Cytochrome C | Myoglobine |
|---|---|---|
| Before washing | + | + |
| pH 3 | + | +/− |
| pH 6 | + | + |
| pH 9 | + | − |

(+) indicates good observation of UV excitation, (+/−) indicates some observation of UV excitation, and (−) indicates no observation of UV excitation.

The results of Examples 6 and 7 show that PANI-ABA surfaces can be used to separate proteins depending on their pI values. Separation of acid and alkali protein/peptides can be carried out directly on the Si-strip surface using tris.HCl buffer or another appropriate solution.

### Example 8

### Mass Spectrometry Analysis of Peptides

Si-strips coated with three layers of PANI-PABA with a molar ratio of aniline : 3-ABA of 3:1 were analyzed on a PS 4000 Enterprise Edition SELDI-MS system (Bio-Rad) in order to test the inherent matrix activity. The arrays were analyzed using peptide standards (ProteoMass MALDI-MS Standards from Sigma-Aldrich). Prior to MS experiments, the polymer surface was washed three times with 4 μL water and air dried. Subsequently, 4 μL peptide solution (100 pmol/μL, dissolved in water) was added to the surface and dried. The spots were analyzed by SELDI-MS without any matrix addition.

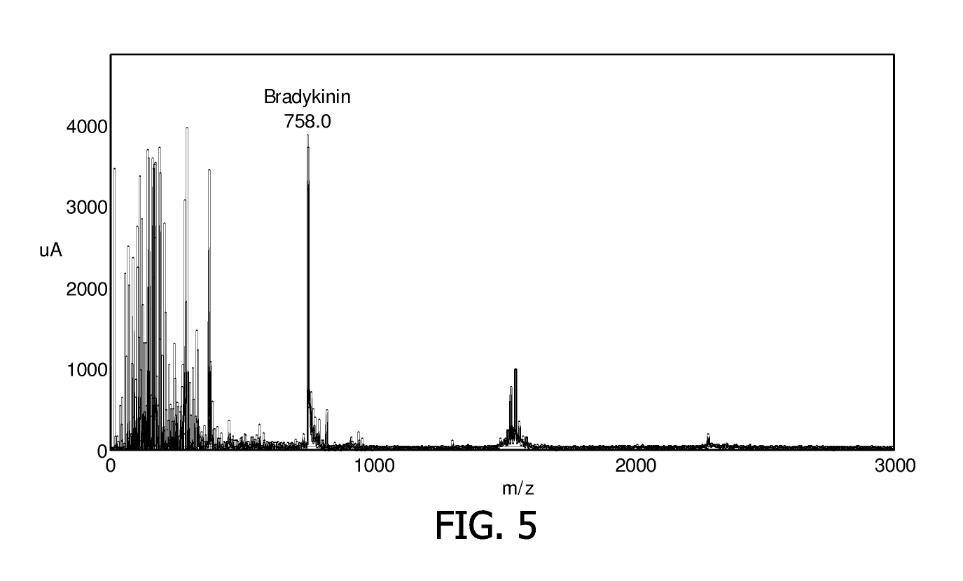

FIG. 5 shows MS spectra of various peptide standards on a polyaniline-coated (PANI-PABA with a molar ratio of aniline : 3-ABA of 3:1) Si-strip. The results illustrate that the polymer coating indeed exhibits inherent MALDI matrix activity. The arrays shows good matrix activity with the formation of intensive protonated molecular ions ([M+H]⁺). No background peaks are observed in the spectra.

### Example 9

Comparison of MS Spectra with and without Use of Matrix Material

PANI-PABA coated Si-strips were analyzed with and without matrix addition, in order to compare the efficiency of conventional sample preparation techniques for analysis of compounds in the low mass region. In the experiments, the two most common matrix types were used: α-cyano-cinnamic acid (CHCA) and sinapinic acid (SPA) (Bio-Rad). Both compounds were used as saturated solutions in acetonitrile:water (1:1, VAT) mixture containing 0.5% trifluoroacetic acid. The arrays were analyzed using Bradykinin 1-7 fragment peptide standard (ProteoMass MALDI-MS Standards from Sigma-Aldrich). Prior to MS experiments, the polymer surface was washed three times with 4 μL water and air dried. Subsequently, 4 μL peptide solution (100 pmol/μL, dissolved in water) was added to the surface and dried. 1 μL matrix solution was added to the surface and dried. The matrix addition step was repeated. Spectra were acquired under the same experimental conditions (Laser energy: 1800, Focus mass: 760 Da, Matrix deflection: 0 Da).

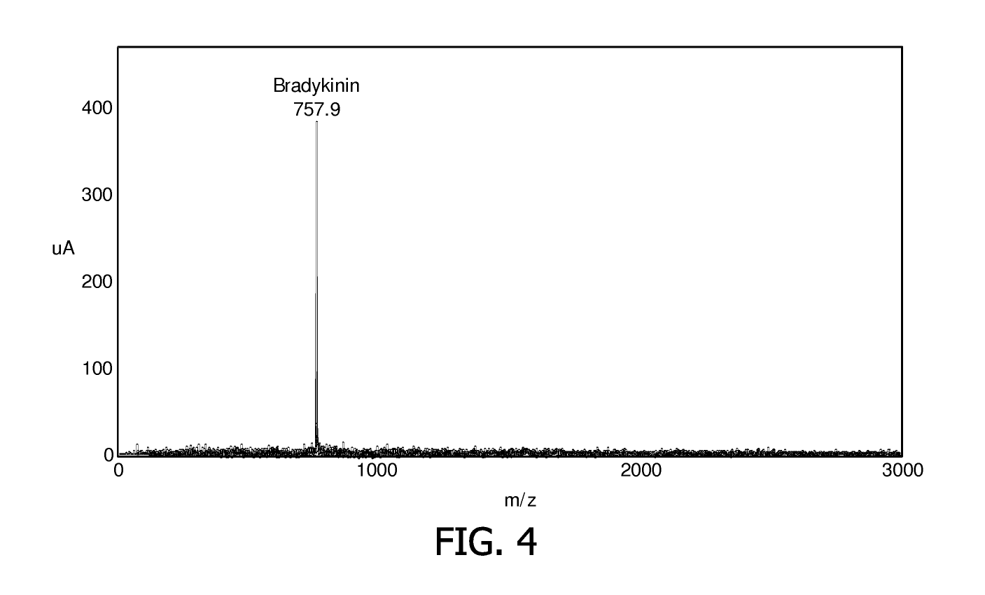

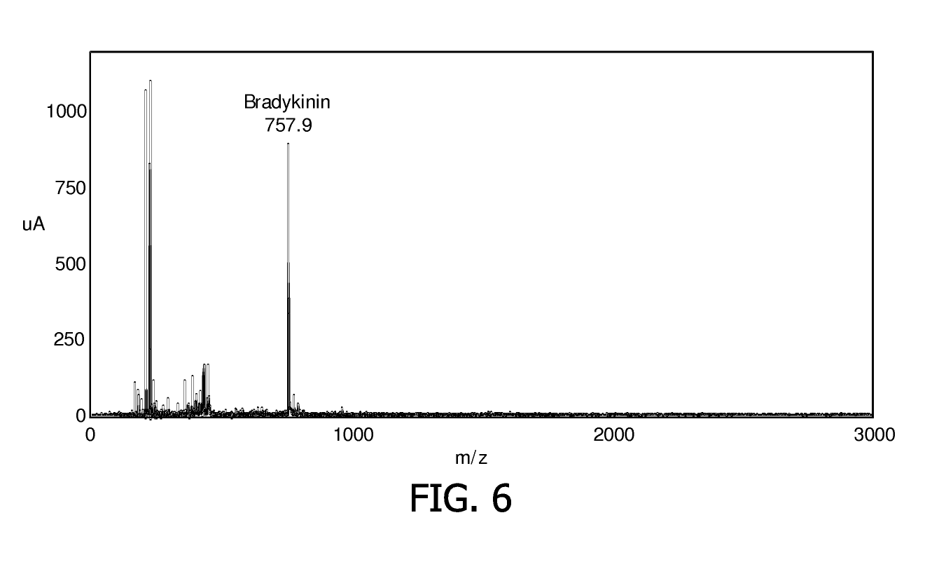

The results show that without addition of extra matrix, no background peaks can be observed from the PANI-PABA coated arrays (see FIG. 4). However, addition of the standard matrix causes the appearance of background ions in the low mass range with high intensity, which hinders the analysis of low molecular weight compounds (see FIGS. 5 and 6).

### Comparative Example 10

Use of Matrix Addition without PANI-PABA Coating

In order to prove, that the inherent matrix activity originates from the polymer surface, experiments were performed with uncoated Si-strips as well. In these experiments, unmodified Si-strips were analyzed using Bradykinin 1-7 fragment peptide standard (ProteoMass MALDI-MS Standards from Sigma-Aldrich). Prior to MS experiments, the surface was washed three times with 4 μL water and air dried. Subsequently, 4 μL peptide solution (100 pmol/μL, dissolved in water) was added to the surface and dried. Matrix was not added to the surface.

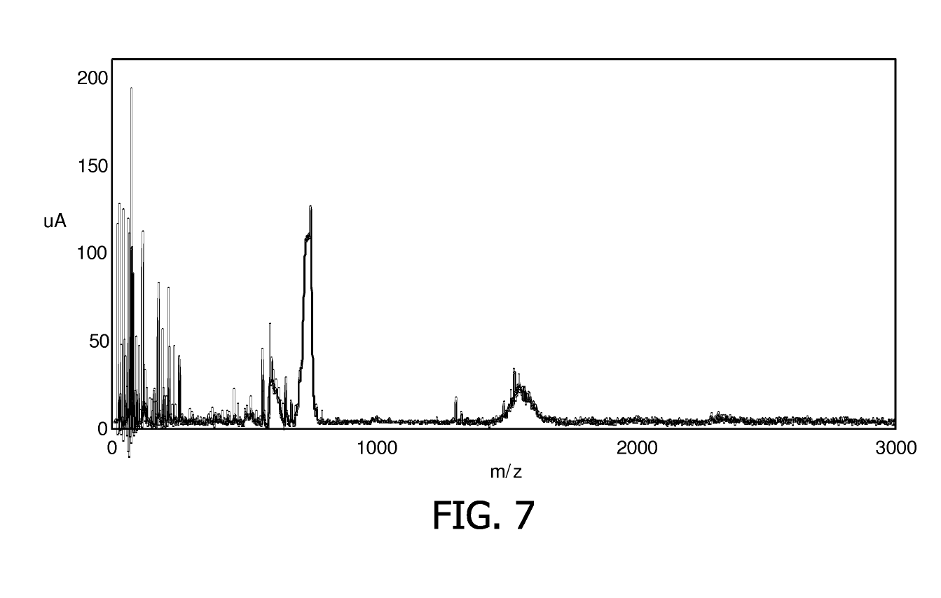

The results show, that the peptide can be detected from an unmodified silicon surface as well, however, the intensity is very low compared to arrays with polymer coating. In addition, the laser irradiation causes strong fragmentation of the analyte. Low molecular weight fragment ions are dominant in the spectra, and due to extensive peak-broadening, the molecular mass determination of the analyte is not possible (see FIG. 7).

### Example 11

Synthesis of Poly(p-nitrophenyl acrylate) (PNA)

N,N-Azobisisobutyronitril (AIBN), corresponding to 3% (w/w) of the monomer, was added to a 1 M solution of p-nitrophenyl acrylate in dry benzene under a stream of nitrogen and kept for 50 h at 70° C. The benzene solution was decanted and the viscous brown residue on the flask walls was dissolved in DMFA to obtain a 1-2% solution. The polymer was re-precipitated with five volumes of methanol. Precipitation was repeated and the clean white residue was washed with methanol and dried. The polymer did not contain residual monomer, short oligomers or AIBN according to TLC (EtOH-Et₂O, 2:1 by vol).

### Example 12

### Coating of PNA on Si-strips

Si-strips were incubated 20 h in boiling water and were dried at 120° C. Subsequently, the Si-strips were aminosilylated with

(1) 5% (w/w) solution of γ-aminopropyl triethoxysilane in 50% methanol at atmospheric pressure at room temperature 0.5 h (under mild mixing). The modified Si-strips were dried at 120° C. 1 h; or

(2) 5% (w/w) solution of y-aminopropyltriethoxysilane in water at atmospheric pressure at room temperature 0.5 h (under mild mixing). The modified Si-strips were dried at 120° C. 1 h; or

(3) 5% (w/w) solution of y-aminopropyltriethoxysilane in boiling toluene 36 h. Subsequently, the Si-strips were washed with toluene, diethylethter, methanol and dried at 120° C. for 1 h.

Chemosorption of obtained PNA on aminosilylated Si-strips was carried out as follows:

Aminosilylated Si-strips in 1% polymer solution in DMF were incubated at 25° C. for 3 h with following determination of surface ester groups concentration after aminolysis by aqueous ammonia with following spectroscopic determination of p-nitrophenol in solution (ε=11000 L/mol×cm, λ=325 nm).

The obtained PNA-coated Si-strips were converted to aminoalkyl-coated Si-strips by reaction with 1,6-hexamethylenediamine (HMDA) by incubation in HMDA solution at 50° C. during 24 h. Subsequently, the Si-strips were washed with DMF, acetone, water and were dried in vacuum.

To obtain carboxylic groups on the surface of thus modified Si-strips, the surface of Si-strips was treated in addition with iodoacetic acid.

1. Process for laser desorption ionization mass spectrometry comprising the steps of
(a) depositing a sample probe comprising a sample molecule on a surface of a sample holder, the surface comprising a polymer comprising aniline or an aniline derivative, or phenyl acrylate or a phenyl acrylate derivative as a UV absorbing aromatic monomer unit;
(b) irradiating the sample probe and/or the surface with a UV laser beam thereby effecting an ionization and/or desorption of the sample molecule; and
(c) determining the mass of the ionized sample molecule.

2. Process according claim 1, wherein said aniline derivative comprises a compound according to Formula I 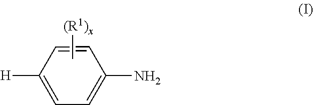
wherein
R¹ is, independently, selected from OH, COOH, halogen, NO₂, NH₂, substituted or unsubstituted, linear or branched alkyl or alkoxy; and
x is 1 to 4.

3. Process according to claim 1, wherein said phenyl acrylate derivative comprises a compound of Formula II 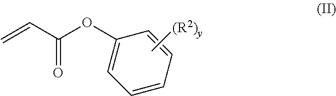
wherein
R² is, independently, selected from OH, COOH, halogen, NO₂, NH₂, substituted or unsubstituted, linear or branched alkyl or alkoxy; and
y is 1 to 5.

4. Process according to claim 1, wherein said UV absorbing aromatic monomer unit is selected from aniline, 3-amino benzoic acid, and p-nitrophenyl acrylate.

5. Process according to claim 1, wherein said polymer is a homopolymer or a co-polymer.

6. Process according to claim 5, wherein said polymer is a homopolymer of aniline, 3-amino benzoic acid, or p-nitrophenyl acrylate, or a co-polymer of aniline and 3-amino benzoic acid.

7. Process according to claim 1, wherein the surface is a coating of a polymer on a substrate of a substrate holder, or a bulk polymer fixed on a substrate holder.

8. Process according to claim 6, wherein the surface is a coating with a layer thickness of less than 500 nm.

9. Process according to claim 7, wherein the substrate is selected from glass, silicon, plastic, resins, metal, metal alloys, foil and paper.

10. Process according to claim 1, wherein the sample probe is deposited on said surface as a solution comprising the sample molecule and a solvent.

11. Process according to claim 10, wherein the solvent is evaporated prior to step (b).

12. Process according to claim 1, wherein the sample probe in step (b) contains no UV absorbing material other than said polymer comprising a UV absorbing aromatic monomer unit, especially no additional UV absorption matrix material.

13. Process according to claim 1, wherein said detecting the mass is achieved by time-of-flight mass spectrometry.
